(19) United States
(12) Patent Application Publication
(10) Pub. No.: US 2008/0097068 A1
(43) Pub. Date: Apr. 24, 2008

(54) Isocyanate-Terminated Prepolymer Composition and a Polyurethane or Polyurea Elastomer Produced Therefrom

(76) Inventors: Verena M.T. Thiede, Muenster (DE); Christian Bruchertseifer, Tecklenburg (DE); Gerhard Mueller, Drensteinfurt-Rinkerode (DE)

Correspondence Address: The Dow Chemical Company, Intellectual Property Section, P.O. Box 1967, Midland, MI, 48641-1967, US

(21) Appl. No.: 11/660,807

(22) PCT Filed: Oct. 11, 2005
(86) PCT No.: PCT/US05/36335

§ 371 Date: Feb. 20, 2007

Related U.S. Application Data
(60) Provisional application No. 60/619,100, filed on Oct. 15, 2004.

(51) Int. Cl. C08L 75/04; C08G 18/10; C08G 18/42; C08G 18/76

(52) U.S. Cl. 528/85

(57) ABSTRACT

The present invention relates to an isocyanate-terminated prepolymer composition obtained from reaction of a methylene diphenylisocyanate, comprising at least 25 weight percent of the 2,4′- isomer, with a polycaprolactone polyol; and to polyurethane or polyurea elastomers obtained from the said isocyanate-terminated prepolymer composition.

The present invention relates to an isocyanate-terminated prepolymer composition obtained by reaction of methylene diphenylisocyanate, having an elevated 2,4′- isomer content, with a polycaprolactone polyol; and to polyurethane or polyurea elastomers obtained from the said isocyanate-terminated prepolymer composition.

Polyurethane elastomers are well known articles of commerce that are frequently characterized by good abrasion resistance, toughness, strength, extensibility, low temperature flexibility, chemical and oil resistance. The level of each of these mechanical and chemical traits is dependent on the inherent properties of the reactants or building block materials making up any particular polyurethane.

There are essentially three reactant types employed when manufacturing polyurethane elastomers; these being the polyols, the polyisocyanates and the chain extenders. It is through selection and ratios of these building blocks coupled with a preparation process that enables a large variety of polyurethane polymer to be manufactured with a wide spectrum of properties. Types of polyurethane elastomers include thermoplastics, thermosets, millable gums, liquid castables, and microcellular elastomers.

The polyol building block is generally a polyether polyol or a polyester polyol depending on the emphasis to particular physical and mechanical properties required to be exhibited by the elastomer. The chain extending agent can be a hydroxyl-containing substance or an amine-containing substance. The polyisocyanate can be an aromatic or aliphatic diisocyanate or a urethane-modified aromatic or urethane-modified aliphatic isocyanate. Elastomers derived from aliphatic isocyanates may be noted as exhibiting attractive resistance to environmental damage such as UV discoloration compared to elastomer based on aromatic isocyanates. Elastomers derived from polyether polyols may be more suitable for application where exposure to moisture or humidity can occur rather than polyester polyol derived elastomers.

In the field of spray elastomers where the polymer can be polyurethane, polyurea or polyurethane-urea polymer it is additionally desirable to provide systems and chemistry along with methods of manufacture which reduce any hazard such as associated with exposure monomer vapors. Such monomer vapors can be the reactants, such as the aliphatic isocyanates and or frequently organic solvents added to modify the viscosity of systems and facilitate the process of elastomer or coating manufacture. It is also desirable to modify either the polyisocyanate or polyol and eliminate one or more deficiencies of many current systems concerning mechanical strength, abrasion resistance, solvent resistance and so forth.

An object of the invention is to provide an isocyanate-terminated prepolymer which is readily converted to an elastomer, preferably in the absence of solvent and where the resulting elastomer exhibits enhanced physical-mechanical properties. It has been found that a particular isocyanate-terminated prepolymer composition based on the reaction of an aromatic polyisocyanate, having an elevated 2,4′-methylene diphenylisocyanate, with a polycaprolactone polyol provides a spray elastomer with enhanced physical properties and addresses the needs in the industry.

In a first aspect, this invention relates to an isocyanate-terminated prepolymer composition that has an isocyanate content of from 1 to 25 weight percent and which is the reaction product of:
a) a polyol composition comprising a polycaprolactone polyol having an average molecular weight of from 400 to 10000 Dalton and an average hydroxyl functionality of from 2 to 4; with
b) a stoichiometric excess of an isocyanate mixture that contains methylene diphenylisocyanate (MDI) in at least about 60 weight percent of the total isocyanate present and wherein the MDI comprises the 2,4′- and 4,4′-methylene diphenylisocyanate isomer in a molar ratio of from 25:75 to 80:20.

In another aspect, this invention relates to an isocyanate-terminated prepolymer composition suitable for spray elastomer applications which has an average isocyanate content of from 5 to 15 weight percent and the prepolymer composition is obtained by reacting a stoichiometric excess of an isocyanate mixture consisting essentially of 2,4′- and 4,4′-methylene diphenylisocyanate present in a molar ratio of from 30:70 to 70:30; with a polyol composition comprising a polycaprolactone polyol or ether-modified polycaprolactone polyol having an average molecular weight of from 400 to 5000 Dalton.

In yet another aspect, this invention relates to polyurethane composition obtained from the reaction of:
a) an isocyanate-terminated prepolymer composition that has an isocyanate content of from 1 to 25 weight percent obtained from the reaction of:
   i) a polyol composition comprising a polycaprolactone polyol having an average molecular weight of from 400 to 10000 Dalton and an average hydroxyl functionality of from 2 to 4; and
   ii)a stoichiometric excess of an isocyanate mixture that contains methylene diphenylisocyanate (MDI) in at least about 60 weight percent of the total isocyanate present and wherein the MDI comprises the 2,4′- and 4,4′-methylene diphenylisocyanate isomer in a molar ratio of from 25:75 to 80:20; with
b) one or more compounds selected from the group consisting of polyether or polyester polyols and polyamine substances , and optionally in the presence of
c) a low molecular weight chain extending agent.

In yet another aspect, this invention relates to a two component system suitable for use in the manufacture of polyurethane elastomers which comprises as individual components:
a) an isocyanate-terminated prepolymer composition as mentioned above; and
b) an isocyanate-reactive composition that contains (i) a polyether or polyester polyol or high molecular weight amine-terminated polyether adduct, or mixtures of two or more thereof; and optionally (ii) a chain extending agent being a low molecular weight dihydroxy substance or an aromatic or aliphatic polyamine, or mixtures of two or more thereof.

The isocyanate-terminated prepolymer composition of this invention is characterized in that it has an average isocyanate content of from 1 to 25, preferably from 5 to 22, and more preferably from 8 to 20 weight percent based on total weight of the composition.

The prepolymer composition is the reaction product of a polycaprolactone or polycaprolactone-polyether polyol with a stoichiometric excess of an isocyanate mixture that contains methylene diphenylisocyanate (MDI) isomers in at least about 60 weight percent of total isocyanate present, and wherein the MDI comprises the 2,4′- and 4,4′-methylene diphenylisocyanate isomers in a molar ratio of from 25:75 to 80:20, preferably from 30:70 to 70:30, and more preferably from 40:60 to 60:40. The balance of the isocyanate mixture when not methylene diphenylisocyanate can comprise any other aliphatic, cycloaliphatic or aromatic isocyanate or derivative thereof, such as, toluene diisocyanate, hexamethylene diisocyanate (HDI), isophorone diisocyanate (IPDI), polymethylene polyphenylisocyanate, 4,4′-methylene bis(cyclohexyl isocyanate) (H12MDI) cyclohexane-bis(isocyanatomethyl) diisocyanate, tetra methyl xylene diisocyanate (TMXDI), carbodiimide, allophonate or uretonimine adducts of methylene diphenylisocyanate, IPDI, HDI, cyclohexane-bis(isocyanatomethyl) diisocyanate and mixtures thereof. Preferred isocyanates to make up the balance of the composition are polymethylene polyphenylisocyanate, carbodiimide or allophonate or uretonimine adducts of methylene diphenylisocyanate. In a particularly preferred embodiment, the isocyanate mixture used to prepare the prepolymer composition consists essentially of 2,4′- and 4,4′-methylene diphenylisocyanate isomers in a molar ratio of from 25:75 to 80:20, preferably from 30:70 to 70:30 preferably from 40:60 to 60:40. Preferably, the isocyanate mixture contains greater than 40% by weight of the 2,4-MDI isomer.

The polycaprolactone or polycaprolactone-polyether polyol used in reaction to obtain the isocyanate-terminated prepolymer belong to the general class of polylactones polyols and can be prepared by the reaction of a lactone monomer; illustrative of which is δ-valerolactone, ε-caprolactone, ε-methyl-ε-caprolactone, ξ-enantholactone, and the like; with an initiator that has active hydrogen-containing groups; illustrative of which is ethylene glycol, diethylene glycol, propanediols, 1,4-butanediol, 1,6-hexanediol, trimethylolpropane, mixtures of two or more thereof, and the like including their oligomers. The production of such polyols is known in the art; see, for example, U.S. Pat. Nos. 3,169,945; 3,021,309; and 3,021,317. Suitable caprolactone ether copolymer polyols may be made from polyethers with a molecular weight of 200 to 2000 and a functionality of 2 to 3, with lactone monomers. The production of such polyols is known in the art, for example see JP Patent 46,007,594 and U.S. Pat. No. 6,632,913. The preferred lactone polyols are the di-, tri- and tetrahydroxyl function ε-caprolactone polyols.

For the present invention the polycaprolactone or polycaprolactone-polyether polyol used in reaction to obtain the isocyanate-terminated prepolymer composition typically has an average molecular weight in the range of 400 to 10,000, preferably from 1,500 to 7,000 and more preferably from 1,500 to 5,000 Dalton. Typically such polyol will have an average functionality in the range of from 2 to 4; preferred are those with a functionality of 2 to 2.5. By functionality, it is understood the number of isocyanate-reactive moieties per molecule, in this instance hydroxyl groups per molecule. Suitable polycaprolactone and caprolactone ether copolymer polyols are commercially available and include products designated as TONE 2241 or TONE 7241 as available from The Dow Chemical Company, or alternatively material designated as CAPA 2200P or CAPA 7201 available from Solvay.

The isocyanate-terminated prepolymer is prepared by standard procedures well known to a person skilled in the art such as disclosed in U.S. Pat. Nos. 4,294,951; 4,555,562; or 4,182,825. The components are typically mixed together, at an excess molar ratio of isocyanate (NCO) to isocyanate reactive group, and heated to promote reaction of the polyols and the polyisocyanate. The reaction temperature will commonly be within the range of 30° C. to 150° C.; a more preferred range being from 60° C. to 100° C. The reaction is advantageously performed in a moisture-free atmosphere. An inert gas such as nitrogen, argon or the like can be used to blanket the reaction mixture. If desired, an inert solvent can be used during preparation of the prepolymer, although none is needed.

The above described isocyanate-terminated prepolymer composition finds utility in the manufacture of elastomers and notably sprays elastomers which can be of the polyurethane, polyurea or polyurethane-polyurea type. Polyurea elastomer is obtained by reaction of the prepolymer composition (A) with an isocyanate-reactive composition (B) that comprises, for the most part, substances containing active hydrogen atoms associated with amine functionality. Polyurethane elastomer result from reaction of the prepolymer composition with isocyanate-reactive composition consisting essentially of substances containing active hydrogen atoms associated with hydroxyl functionality. Isocyanate-reactive composition comprising a mixture of hydroxyl and amine functionality when reacted with the prepolymer will result in a hybrid product; a polyurethane-urea elastomer.

The active hydrogen-containing materials include, but are not necessarily limited to polyols or high molecular weight polyoxyalkyleneamines, also described herein as amine-terminated polyethers, or a combination thereof.

The polyols include, but are not necessarily limited to, polyether polyols, polyester diols, triols, tetrols, etc., having an equivalent weight of at least about 500, and preferably at least about 1,000 up to about 3,000. Those polyether polyols based on trihydric initiators of about 4,000 molecular weight and above are especially preferred. The polyethers may be prepared from ethylene oxide, propylene oxide, butylene oxide or mixtures of propylene oxide, butylene oxide and/or ethylene oxide present as random mixtures or as blocks. Other high molecular weight polyols which may be useful in this invention are polyesters of hydroxyl-terminated rubbers, for example, hydroxyl- terminated polybutadiene. Hydroxyl-terminated quasi-prepolymers of polyols and isocyanates are also useful in this invention.

Especially preferred are amine-terminated polyether polyols, including primary and secondary amine-terminated polyether polyols of greater than 1,500 average molecular weight having from 2 to 6 functionality, preferably from 2 to 3, and an amine equivalent weight of from 750 to 4,000. Mixtures of amine- terminated polyethers may be used. In a preferred embodiment, the amine- terminated polyethers have an average molecular weight of at least about 2,500. These materials may be made by various methods known in the art.

The amine-terminated polyether resins useful in this invention, for example, are polyether resins made from an appropriate initiator to which lower alkylene oxides, such as ethylene oxide, propylene oxide, butylene oxide or mixtures thereof, are added with the resulting hydroxyl- terminated polyol then being aminated. When two or more oxides are used, they may be present as random mixtures or as blocks of one or the other polyether. In the amination step, it is highly desirable that the terminal hydroxyl groups in the polyol be essentially all secondary hydroxyl groups for ease of amination. Normally, the amination step does not completely replace all of the hydroxyl groups. However, the majority of hydroxyl groups are replaced by amine groups. Therefore, in a preferred embodiment, the amine-terminated polyether resins useful in this invention have greater than 50 percent of their active hydrogens in the form of amine hydrogens. If ethylene oxide is used, it is desirable to cap the hydroxyl-terminated polyol with a small amount of higher alkylene oxide to ensure that the terminal hydroxyl groups are essentially all secondary hydroxyl groups. The polyols so prepared are then reductively aminated by known techniques, for example, as described in U.S. Pat. No. 3,654,370, the disclosure of which is incorporated herein by reference.

In the practice of this invention, a single high molecular weight amine-terminated polyether may be used. Also, mixtures of high molecular weight amine-terminated polyethers, such as mixtures of di- and trifunctional materials and/or different molecular weight or different chemical composition materials, may be used.

Also, high molecular weight amine-terminated polyethers or simply polyether amines are included within the scope of my invention and may be used alone or in combination with the aforestated polyols. The term “high molecular weight” is intended to include polyether amines having a molecular weight of at least about 2000. Particularly preferred are the JEFFAMINE® series of polyether amines available from Huntsman Corporation; including JEFFAMINE D-2000, JEFFAMINE D- 4000, JEFFAMINE T-3000 and JEFFAMINE T-5000.

Although not required, when preparing elastomers it is advantageous to use a chain extending agent in combination with the polyol and/or amine-terminated polyether. Typically the chain extending substance is a low molecular weight dihydroxyl; or polyamine, aromatic or aliphatic, substance or mixtures thereof. By low molecular weight it means a substance having a molecular weight below the range quoted for the above polyol or amine-terminated polyether. Typically the chain extending agent will have an equivalent weight of less than 500, preferably less than 300 and more preferably less than 150 Dalton. Illustrative of chain extending agents are the dihydroxyl compounds such as 1,4-butanediol, 1,6-hexanediol and the polyoxyalkylene diols based on ethylene oxide, propylene oxide and or butylene oxide. Polyamine, preferable diamine chain extenders include those aliphatic and cycloaliphatic diamine chain extenders mentioned in U.S. Pat. No. 5,162,130, the disclosure of which is incorporated herein by reference and aromatic diamines such diethyl toluene diamine.

In one embodiment of this invention the isocyanate-terminated prepolyrner composition component may also include an organic alkylene carbonate. The alkylene carbonates are preferably chosen from the group of ethylene carbonate, propylene carbonate, butylene carbonate and dimethyl carbonate. The proportion of alkylene carbonate component ranges from 1 to 20 percent, preferably from 5 to 15 percent and most preferably from 5 to 10 percent, based on total weight of isocyanate-terminated prepolymer composition and alkylene carbonate. The use of the alkylene carbonates reduces the viscosity of the isocyanate component, allows slower effective reactivities in spray polyurea elastomer systems, improved properties and surface characteristics (flowability) and possibly improved adhesion to the surfaces on which the elastomer is sprayed.

Other conventional formulation ingredients may be employed in the isocyanate prepolymer composition or isocyanate-reactive composition as needed, such as, for example, foam stabilizers, also known as silicone oils or emulsifiers. The foam stabilizers may be an organic silane or siloxane. For example, compounds may be used having the formula: RSi[O-(R2SiO)n-(oxyalkylene)mR]3 wherein R is an alkyl group containing from 1 to 4 carbon atoms; n is an integer of from 4 to 8; m is an integer of from 20 to 40; and the oxyalkylene groups are derived from propylene oxide and ethylene oxide. See, for example, U.S. Pat. No. 3,194,773, the disclosure of which is incorporated herein by reference. Pigments, for example titanium dioxide, may be incorporated in the elastomer system, preferably in the isocyanate-reactive composition, to impart color properties to the elastomer.

Reinforcing materials, if desired, useful in the practice of the invention are known to those skilled in the art. For example, chopped or milled glass fibers, chopped or milled carbon fibers and/or other mineral fibers are useful.

Post curing of the elastomer of the invention is optional. Post curing will improve some elastomeric properties, such as heat sag. Employment of post curing depends on the desired properties of the end product. The prepolymer component and isocyanate-reactive component streams of the present spray polyurea elastomer system are combined or mixed under high pressure; most preferably, they are impingement mixed directly in the high pressure spray equipment. In particular, a first and second pressurized stream of the components are delivered from two separate chambers and are impacted or impinged upon each other at high velocity to effectuate an intimate mixing of the two components and, thus, the formulation of the elastomer system, which is then coated onto the desired substrate via the spray gun.

The volumetric ratio of the isocyanate-terminated prepolymer composition to the isocyanate-reactive composition is generally from 30 to 70 percent to 70 to 30 percent. Preferably, the compositions are deployed in a 1:1 volumetric ratio.

Advantageously, the system components react to form the present elastomer system without the aid of a catalyst. If required, as catalysts as well known to the person skilled in the art of manufacturing polyurethane or polyurea elastomer can be incorporated.

The following examples are given to illustrate the invention and should not be interpreted as limiting it in any way. Unless stated otherwise, all parts and percentages are by weight.

Preparation of Isocyanate-Terminated Prepolymer Compositions

Prepolymer compositions 1 to 3 and Comparative Prepolymer A are prepared with reactants as detailed in Table 1.

ISONATE OP 50 available from The Dow Chemical Company is a 50:50 mixture of 2,4-MDI and 4,4′-MDI isomers.

VORANOL 2000—is a 2000 molecular weight polyoxypropylene diol available from The Dow Chemical Company.

VORANOL 1010—is a 1000 molecular weight polyoxypropylene diol available from The Dow Chemical Company.

TONE 2221—a polycaprolactone polyol derived from neopentyl glycol (functionality 2; molecular weight 1000) available from The Dow Chemical Company.

TONE 2241—a polycaprolactone polyol neopentyl glycol (functionality 2; molecular weight 2000) available from The Dow Chemical Company.

TONE 1241—a polycaprolactone polyol derived from butane glycol (functionality 2; molecular weight 2000) available from The Dow Chemical Company.

TONE 0201—a polycaprolactone polyol derived from diethyleneglycol (functionality 2; molecular weight 500) available from The Dow Chemical Company.

TABLE 1

| Parts by | Prepolymer | Prepolymer | Prepolymer | Prepolymer |
|---|---|---|---|---|
| weight | A | 1 | 2 | 3 |
| ISONATE | 53.79 | 53.79 | 53.37 | 64.54 |
| OP 50 | | | | |
| Benzoyl | 0.02 | 0.02 | 0.02 | 0.02 |
| Chloride | | | | |
| VORANOL | 34.65 | / | / | / |
| 2000 | | | | |
| VORANOL | 11.54 | / | / | / |
| 1010 | | | | |
| TONE 2221 | / | 11.54 | / | |
| TONE 2241 | / | 34.65 | / | |
| TONE 1241 | / | | 46.41 | / |
| TONE 0201 | / | / | / | 35.44 |
| Final NCO % | 16.0 | 16.0 | 16.0 | 16.0 |
| Viscosity | 1500 mPas | Not | Not | 5500 |
| at 20 C. | | observed | observed | |

Preparation of Elastomers

Elastomers are prepared with reactants as detailed in Table 2. Elastomers 1 to 3 are polyurea elastomers; Elastomers 4 to 6 are polyurethane-urea hybrid elastomers. E-1 and E-4 are comparative elastomers being based on prepolymer not derived from a polycaprolactone polyol. The prepolymer component is present in amount to provide for an isocyanate reaction index of 100.

Polyol A a polyoxypropylene triamine polyol of molecular weight 2000, available as Poly A27-2000 from Arch Chemicals.

Polyol A a polyoxypropylene triamine polyol of molecular weight 5000, available as Poly A37-5000 from Arch Chemicals.

Polyol C a polyoxypropylene diamine of molecular weight 400, JEFFAMINE D-400 available from Huntsman.

Polyol D diethyl toluene diamine (DETDA).

Polyol E a glycerine initiated polyol of molecular weight 4800, VORANOL CP4702 available from The Dow Chemical Company.

Polyol F a polycaprolactone polyol of molecular weight 530, TONE 0305 available from The Dow Chemical Company.

Catalyst a blend of dibutyltin dilaurate and DABCO 33LV, available from Air Products.

Additive VORATRON EG 711 available from The Dow Chemical Company

Physical properties where reported are observed according to the following test procedures:

| | |
|---|---|
| Abrasion | ASTM D 3389 |
| Resilience | ASTM D 2632 |
| Hardness | ASTM D 2240 |

Inspection of the reported properties clearly indicates that elastomer obtained from prepolymer compositions of this invention overall show superior physical properties relative to the comparative systems. General enhancement of elongation, tear strength and abrasion resistance is obtained. Water and chemical resistance properties are general improved with significant reductions in average weight increases being reported when elastomers are exposed under controlled conditions to various substances.

| Part by weight | E - 1* | E - 2 | E- 3 | E- 4* | E- 5 | E- 6 |
|---|---|---|---|---|---|---|
| Prepolymer at Index 100 | A | 1 | 3 | A | 1 | 3 |
| Polyol A | 59 | 59 | 59 | / | / | / |
| Polyol B | 10 | 10 | 10 | / | / | / |
| Polyol C | 5 | 5 | 5 | / | / | / |
| Polyol D | 26 | 26 | 26 | 16.7 | 16.7 | 16.7 |
| Polyol E | / | / | / | 43.7 | 43.7 | 43.7 |
| Polyol F | / | / | / | 34 | 34 | 34 |
| Catalyst | / | / | / | 0.3 | 0.3 | 0.3 |
| Additive | / | / | / | 4.75 | 4.75 | 4.75 |
| Tensile Strength (N/mm2) | 17 | 25 | 25 | 11 | 12 | 20 |
| Elongation % | 355 | 351 | 279 | 141 | 157 | 152 |
| Tear (N/mm) | 61 | 80 | 98 | 26 | 34 | 55 |
| Shore D | 44 | 48 | 58 | 35 | 36 | 52 |
| Abrasion (mm3) | 347 | 173 | 146 | 162 | 157 | 135 |
| Water absorption ASTM D 570-98; | 2.21 | 1.85 | 1.92 | 2.57 | 2.19 | 1.93 |
| increase in weight at 1 week (%) | | | | | | |
| Chemical resistance ASTM D 543-95 | | | | | | |
| increase in weight after 1 week (%) | | | | | | |
| 30% H₂SO₄ solution | 0.99 | 0.69 | 0.66 | 1.02 | 0.93 | 0.57 |
| 10% NaCl aq solution | 1.09 | 0.87 | 0.97 | 1.17 | 0.88 | 0.92 |
| 10% NaOH aq solution | 0.92 | 0.70 | 0.84 | 0.94 | 0.60 | 0.66 |

*Comparative Example

That which is claimed:

1) An isocyanate-terminated prepolymer composition that has an isocyanate content of from 1 to 25 weight percent and which is the reaction product of:
a) a polyol composition comprising a polycaprolactone polyol having an average molecular weight of from 400 to 10000 Dalton and an average hydroxyl functionality of from 2 to 4; with
b) a stoichiometric excess of an isocyanate mixture that contains methylene diphenylisocyanate (MDI) in at least about 60 weight percent of the total isocyanate present and wherein the MDI comprises the 2,4′- and 4,4′-methylene diphenylisocyanate isomer in a molar ratio of from 25:75 to 80:20.

2) The isocyanate-terminated prepolymer composition of claim 1 having an average isocyanate content of from 8 to 20 weight percent.

3) The isocyanate-terminated prepolymer composition of claim 1 wherein the isocyanate mixture (b) consists essentially of 2,4′- and 4,4′-methylene diphenylisocyanate.

4) The isocyanate-terminated prepolymer composition of claim 3 wherein the 2,4′- and 4,4′-methylene diphenylisocyanate isomers are present in a molar ratio of from 30:70 to 70:30.

5) The isocyanate-terminated prepolymer composition of claim 1 wherein the polyol comprises a polycaprolactone polyol having an average molecular weight of from 400 to 5000 Dalton and an average hydroxyl functionality of from 2 to 4.

6) A isocyanate-terminated prepolymer composition suitable for spray elastomer applications which has an average isocyanate content of from 8 to 20 weight percent in is obtained by reacting a stoichiometric excess of an isocyanate mixture consisting essentially of 2,4′- and 4,4′-methylene diphenylisocyanate present in a molar ratio of from 30:70 to 70:30; with a polyol composition comprising a polycaprolactone polyol or ether-modified polycaprolactone polyol having an average molecular weight of from 400 to 5000 Dalton

7) A polyurethane composition obtained from the reaction of:
a) an isocyanate-terminated prepolymer composition that has an isocyanate content of from 1 to 25 weight percent and which itself is obtained from the reaction of:
i) a polyol composition comprising a polycaprolactone polyol having an average molecular weight of from 400 to 10000 Dalton and an average hydroxyl functionality of from 2 to 4; with
ii) a stoichiometric excess of an isocyanate mixture that contains methylene diphenylisocyanate (MDI) in at least about 60 weight percent of the total isocyanate present and wherein the MDI comprises the 2,4′- and 4,4′-methylene diphenylisocyanate isomer in a molar ratio of from 25:75 to 80:20; with
b) one or more compounds selected from the group consisting of high molecular weight polyether or polyester polyols or polyamine substances, and optionally in the presence of
c) a low molecular weight chain extending agent.

8) The polyurethane composition of claim 7 wherein the chain extending agent c) when present is a dihydroxy substance.

9) The polyurethane composition of claim 7 wherein the chain extending agent c) when present is an aromatic or aliphatic polyamine.

10) A two component system suitable for use in the manufacture of polyurethane elastomers which comprises as individual components:
a) an isocyanate-terminated prepolymer composition as claimed in claim 1; and
b) an isocyanate-reactive composition that contains (i) a polyether or polyester polyols or high molecular weight amine-terminated polyoxyalkylene adduct, or mixtures of two or more thereof; and optionally (ii) a chain extending agent being a low molecular weight dihydroxy substance or an aromatic or aliphatic polyamine, or mixtures of two or more thereof.
